(19) United States
(12) Patent Application Publication
(10) Pub. No.: US 2005/0024188 A1
(43) Pub. Date: Feb. 3, 2005

(54) Thermosafe life alert system

(76) Inventor: Dale Sider, Nashville, TN (US)

Correspondence Address: BANNER & WITCOFF, 1001 G STREET N W, SUITE 1100, WASHINGTON, DC, 20001, US

(21) Appl. No.: 10/734,156

(22) Filed: Dec. 15, 2003

Related U.S. Application Data
(60) Provisional application No. 60/491,039, filed on Jul. 29, 2003.

(51) Int. Cl. B60Q 1/00

(52) U.S. Cl. 340/425.5; 340/584; 340/457

(57) ABSTRACT

A vehicle safety system for preventing injury or death to persons or animals at risk of exposure to extreme temperatures within the vehicle. The system determines when a temperature within a vehicle is greater than or less than predetermined temperatures and also detects movement within the vehicle. As a result of a temperature being determined to be critical and movement being detected within a vehicle, certain responsive measures are automatically taken to alert the owner/operator and/or would-be rescuers of the potentially injurious situation present within the vehicle and/or to assist in a possible rescue.

This application claims priority to provisional U.S. Application Ser. No. 60/491,039 filed Jul. 29, 2003.

### FIELD OF THE INVENTION

The invention relates generally to a vehicle safety system. More specifically, the invention provides a method of and system for protecting humans or animals from injury or death that may occur should they be confined within a vehicle under certain temperature conditions.

### BACKGROUND OF THE INVENTION

It is estimated that over 400 children died of heatstroke when left alone in hot cars in the Untied States over the last five years. In the summer of 1999, an average of one child died every four days after being trapped in a car parked in the searing heat. One-third of the heat-related deaths occurred when children crawled into unlocked cars while playing and became trapped. Additionally, countless pets such as dogs, and cats have died or suffered temperature related injuries when left within a car. Injuries to children due to exposure to extreme temperatures continually occur despite the current measures being taken. Temperatures can mount so rapidly within a vehicle that it may overtake a child's ability to regulate their own body temperature. Further, child death due to heatstroke is estimated to be the second leading preventable cause of death.

Existing vehicle safety detection systems attempt to determine if a child is in a vehicle and if the temperature is too extreme. If a child is believed to be in the vehicle, an alarm may be sounded. For example, U.S. Pat. No. 6,104,293 to Rossi discloses a warning system for detecting the presence of a child in an infant seat. In Rossi, the warning system is designed to provide an initial warning when the car is turned off and a child remains in a car seat within the vehicle.

Alternatively, U.S. Pat. No. 5,054,686 to Chuang discloses an automatic venting system for a vehicle having a plurality of motor operated vents. If it is determined that there is a living being within the vehicle while the temperature within the vehicle is above a threshold value, the system opens a vent. However, if precipitation is detected, the vents are closed unless the living being is detected within the vehicle. If a being is detected, at least one of the vents remains open.

Additional attempted safety system solutions include U.S. Pat. Nos. 5,793,291 ('291) and 5,966,070 ('070), both to Thornton. The '291 and '070 patents disclose an alarm system for indicating that a child is detected in a child seat, and that the temperature within the vehicle is above or below an extreme temperature. However, these systems do not facilitate rescues by bystanders, rescue services, or even intervention by an owner/operator of the vehicle when the owner/operator is physically located outside hearing distance from the vehicle.

These systems fail to provide an ideal system for letting bystanders assist in saving children or pets. Bystanders may find themselves in a position where they are aware of a person in peril, however, due to the vehicle being locked, they are unable to provide assistance without risk of injury to themselves and/or the person they are attempting to assist and rescue. An improved vehicle safety system was thus needed.

### BRIEF SUMMARY OF THE INVENTION

To overcome limitations in the prior art described above, and to overcome other limitations that will be apparent upon reading and understanding the present specification, the present invention is directed to a system for protecting beings and/or animals within a vehicle from injury or death as a result of exposure to conditions within the vehicle.

A first aspect of the invention provides a system for determining whether a living being is within a vehicle when the temperature is above or below predetermined temperatures and alerting others to the potentially injurious situation. The system may make a call to an owner/operator, a governmental entity, rescue entities such as police and fire departments, and/or “911” upon a determination that the temperature is too high or too low and motion is detected within the vehicle. The system may sound an alarm, flash headlights, or honk a horn.

A second aspect of the invention provides a system for determining whether a living being is within a vehicle when the temperature is above or below predetermined temperatures and facilitating assistance or rescue to the being. One or more of the doors may be unlocked to allow bystanders to assist the being subject to injury within the vehicle. Phone calls may be placed in conjunction with a global positioning system (GPS) to provide the location of the vehicle containing the being.

A third aspect of the invention provides a system for determining whether a living being is within a vehicle when the temperature within the vehicle is above or below predetermined temperatures and then reducing the risk of or alleviating the potentially injurious situation until the owner/operator returns or assistance is provided. For example, upon determination that the temperature is too high a window may be lowered, vents opened, or the air conditioning may be turned on. If the temperature is too low, the heat may be turned on.

The system described herewithin is capable of preventing numerous needless deaths and injuries due overheating each year. Similarly, the system disclosed may prevent injury to children by notifying parents that the child, unknown to the parents, has entered a vehicle in an attempt to play within the vehicle.

These and other objects and features of the invention will be apparent upon the consideration of the following detailed description of the preferred embodiment thereof, presented in connection with the following drawings.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is an exemplary schematic diagram of components of the safety system.

FIG. 2 is an exemplary side view of a vehicle containing the safety system.

FIG. 3 is a flow diagram illustrating logic of one exemplary embodiment of a safety system.

### DETAILED DESCRIPTION OF THE INVENTION

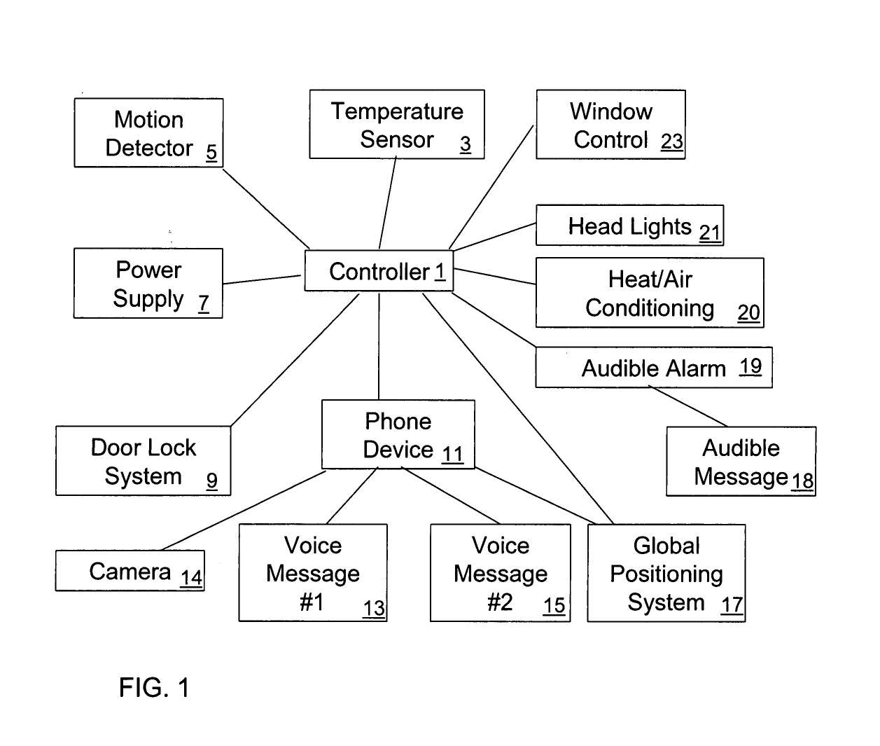

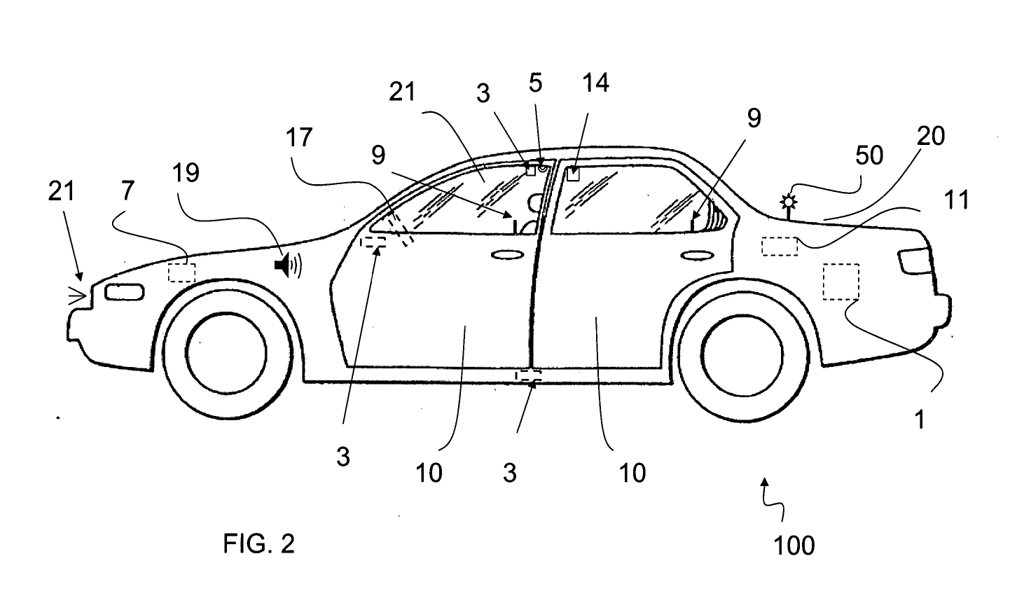

FIG. 2 shows a vehicle 100 embodying such a vehicle safety system according to the present invention. FIG. 1 shows one exemplary embodiment of the system of the present invention as including a controller 1, temperature sensors 3, a motion detector 5, a power supply 7, a door lock system 9, a phone device 11, and a camera 14.

The system may also interact with and/or be integrated with, various components of the vehicle 100. The system may be connected to an audible alarm system 19 and/or an anti-theft system resident in the vehicle. It may also be connected to the headlights 21 of the vehicle. The system may also be connected to the window and window controls 23 of the vehicle. A global positioning system (GPS) 17 may also be utilized and controlled to supply positioning data. Any cellular or other types of wireless communication or transmission may utilize an antenna 50 attached to the vehicle or any conventional antenna known in the art. The safety system components and various other components of the vehicle may connect to a controller 1 for control and/or coordination.

The placement of the system within the vehicle may be made according to vehicle-type and specific system configuration. The entire system may be placed in a single unit or connected components may be dispersed throughout the vehicle system. For example, a temperature sensor 3, motion detector 5, and camera 14 may be centrally located within a single unit in the roof of the vehicle. In vehicles such as daycare vans and convertibles, the system may also be located within the armrest. Alternative mounting locations for the entire system or components such as the controller 1 or temperature sensors 3 may include positions under the seats, in the seats or head rests, or within the dashboard of the vehicle.

FIG. 2 shows a controller 1 mounted in the trunk 20 of the vehicle. The controller 1 may act as the brain and central command of the system making logic decisions for the system. Data observed at sensors or detectors within the system may also be sent back to the controller 1 for processing. The controller 1 may be integrated with existing processing components within a vehicle or may be built directly into the vehicle upon initial manufacturing. In an exemplary embodiment, the controller I is electronic processing circuitry and may include digital and/or analog circuitry, a microprocessor and/or other electronic logic devices.

Controller 1 along with the other components within the system are powered by a power supply 7. A car battery, which is used to provide electricity to other apparatus within the vehicle such as the radio, lights and the starter may serve as a power supply 7. Similarly, an isolated power source distinct from the battery may also serve as a power supply 7 for the system. Further, solar cells in conjunction with a battery or storage site may be used either alone or in cooperation with the vehicle's battery and electrical system.

One or more temperature sensors 3 are also connected to the controller and provides temperature readings back to the controller 1. FIG. 2 depicts the placement of three temperature sensors, one located in the dashboard of the vehicle, a second located in the floor of the passenger compartment of the vehicle, and a third located in the roof of the passenger compartment of the vehicle. The placement and number of temperature sensors 3 may be varied depending on the configuration of the vehicle and the sensors used. Placement of the temperature sensors 3 may be made so as to provide a more accurate temperature reading for a given position within the passenger compartment of the vehicle. Since the temperature readings may vary depending on locale within the vehicle where the temperature is being determined, an average or mean temperature may also be calculated by the controller 1 based upon the readings provided by various temperature sensor 3 readings. Alternatively, the controller 12 may use the most extreme reading (i.e. maximum temperature in heat conditions and the minimum temperature in cold conditions).

Also attached to the controller 1 is a motion detector 5. In the vehicle 100 depicted in FIG. 2, the motion detector 5 is located in the ceiling towards the middle of the vehicle. Positioning of the motion detector 5 will vary based upon the configuration of the vehicle, especially the passenger compartment. The motion detector 5 transfers readings regarding movement within the passenger compartment back to the controller 1 for processing. The motion detector 5 may be of any technology known in the art.

The controller 1 may also be attached to the door locks 9 of the vehicle 100. Many vehicles have power door locks 9. The controller 1 may be connected to the power locks so as to allow the controller to 1 unlock one or more of the doors 10 by sending an electric command. Vehicles, typically, do not have to be running in order for the power locks 9 to be used. By unlocking the doors 10, bystanders will be able to open the door to assist and rescue the persons or animals inside without breaking a window or using other more dangerous actions to enter. The risk of serious injury to themselves or to a child or animal inside the compartment may thereby be reduced.

The vehicle 100 depicted in FIG. 2 also contains portable telephone capabilities. In this vehicle 100, a phone device 11 has been placed within the trunk 20 of the vehicle 100. If desired, components from the phone device 11 may include a cellular or similar technology for communicating from various mobile locations. Cellular phone devices are well known in the art and numerous types of cellular and portable phone devices may be utilized. The phone device 11 may be capable of automatically dialing predetermined telephone numbers. The predetermined numbers may include the phone number of, for example, an emergency response organization such as “911”, the state police headquarters, a private response service or an operator. The number may also be the owner of the device's cell phone number, PDA, pager or other similar device. The user may enter (e.g. program) any number they desire into this phone device and this number may easily be changed as desired.

Once the phone device 11 has been programmed to dial the predetermined number, the phone may play a prerecorded message. Such message may be a custom message recorded by the user or it may be a standard distress or information message. A plurality of voice messages (e.g. 13 and 15) may be recorded and stored for playing by the phone device 11. If desired, a user may activate a default-prerecorded message for play by the phone device 11. Factors such as time of day and location of the vehicle may also be used in a determination by the phone device as to which message to play. As such, a sample message could include a description of the vehicle, the license plate number, and whether a child and/or an animal is likely to be in the vehicle. For example, the message may state: “Help is requested immediately to 1600 Illinois Avenue, Nashville, Tenn., where an infant girl named ‘Dana’ and a Cocker Spaniel that answers to the name ‘Penny’ are overheated and inside a 1993 Black Chevy Blazer®, Tennessee plate number ABCD-123.”

Additionally, if desired, a camera 14 may also be connected to the phone device 11. The camera 14 may be positioned in the roof, the dashboard or in a console or armrest and configured to capture pictures. Images from the camera 14 may be sent over the phone connection to the receiver of the call when the phone device 11 makes a call. This way the receiver of the call, e.g. the user or an emergency service can determine if there is a false alarm or not, and if it is a real emergency the person receiving the images may be able to determine the condition or health of the person and/or animal inside. For example, a cell phone with a camera and/or display capable of showing images, photos or video may display images taken from the camera within the passenger compartment of the vehicle 100.

In one embodiment of the system a GPS 17 may be incorporated into the system and may be connected to the controller 1 and to the phone device 11. Some existing vehicles may be equipped with a GPS 17 to assist the driver in navigation and this technology is known in the art. These systems can often provide real-time location of a vehicle 100 utilizing the system. The GPS location may be utilized in coordination with the phone device 11 providing a location of the vehicle to an emergency response number, an automotive assistance company, state police and fire departments etc. Speech technology that is well known in the art would allow the location of the vehicle 100, as well as a vehicle description, to be conveyed via telephone with the automated voice technology. The ability to provide additional knowledge of the location of a child or animal locked or restrained within the vehicle 100 will facilitate any attempted response by rescuers or owners/operators of the vehicles.

Rescue may also be facilitated through utilizations of an audible alarm 19 in coordination with the system. Many vehicles today are built with alarms or configured to allow owners to add them after purchase. The alarm 19 may be attached to the controller 1. In lieu of or in addition to audible alarm 19, the controller 1 may also be coupled to the horn of the vehicle 100. Upon determination that a being is within the vehicle 100 concurrent to the temperature in the vehicle exceeding or failing to reach certain acceptable temperatures, the controller 1 may sound an alarm to alert bystanders to the vehicle. The alarm may be an audible voice announcement and/or a non-voice alarm such as a siren or horn. With the development of voice and speech technology the system may be programmed to provide a generic distress message such as, “EMERGENCY, remove occupant from vehicle. Someone is trapped in the vehicle that may be injured.” This warning may be repeated until the occupant has been removed. Alternatively, the message may be repeated until a certain amount of time has elapsed. A user may also record a custom message. Further, headlights 21 or other vehicle lights may alternatively be flashed repeatedly to draw attention to the vehicle rather than an alarm 19. An alarm 19, headlights 21 or any similar attention drawing device may be attached to the controller 1 and initiated when a being, susceptible to injury due to unacceptable temperatures sensed within the vehicle, is determined to be within the car.

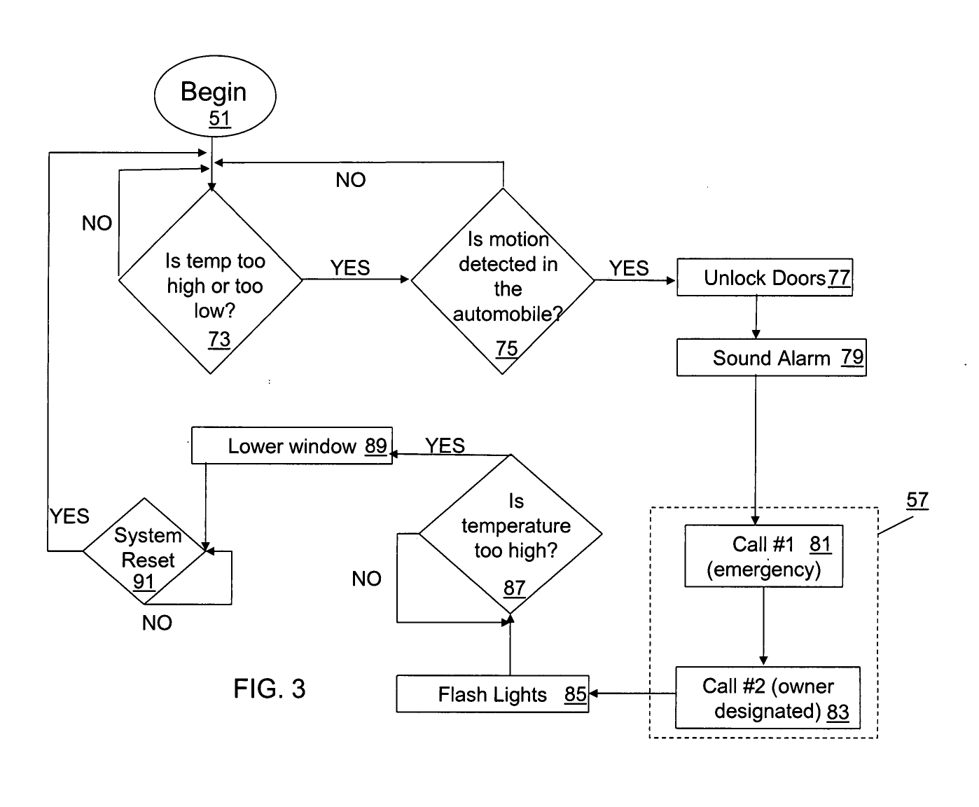

FIG. 3 describes the operation of one exemplary embodiment of the vehicle safety system. Once the system is activated 51, one or more temperature sensors 3 within the vehicle 100 supply readings used to determine the temperature within the vehicle and whether that temperature is above certain values (e.g. 100° F.) or below certain values (32° F.) at step 73. For example, the temperature sensors may determine that the temperature within the vehicle is above 100° F. The values used for comparison purposes may be supplied from a variety of different sources. The user may enter default values, certain system specific standards may be entered, values specific to the user's home state or city may be entered, or values may be determined automatically based upon the make and model of vehicle and type and/or number of sensors within the system, just to name a few. These temperature readings may be continuously compared against the predetermined values.

Further, the detection of a temperature maintained above or below a certain level for designated period of time may also be used as the determining criteria for when conditions are too extreme. Any timing devices known in the art may be utilized. For example, the system may be set to detect if a temperature remains above 95° F. for more than 5 minutes continuously. This temperature and time detection criteria may be used in conjunction with or alternatively to detection of a temperature occurrence above or below a certain value. For example, the system may, if desired, be set so the temperature is considered critical if a temperature is detected within the vehicle above 105° F. for even just a moment and/or a temperature detected within the vehicle above 95° F. that is sustained continuously for more than 5 minutes.

Upon a determination that the temperature is critical (e.g. exceeds or falls below a certain predetermined value), a motion detector 5 determines whether any living beings are within the vehicle. If it is determined that the temperature is critical and motion is detected within the vehicle, then the controller 1 activates a rescue sequence and takes steps to alert bystanders, owners or operators, the authorities, the fire or police department and/or other governmental response teams. Additionally, certain steps utilize existing vehicle components to facilitate intervention such as the unlocking of doors etc. FIG. 2 illustrates an exemplary rescue sequence. The particular rescue sequence may be varied as desired. The components illustrated, as well as other components known in the art, may be utilized in the rescue sequence. Fewer or more components or features may be used if desired.

FIG. 3 describes an exemplary embodiment of a vehicle safety system utilizing temperature sensing and motion detection to prevent injury to persons or animals inside. In this particular embodiment, a determination is made as to whether the temperature 73 is critical (i.e. above or below certain predetermined values) based at least in part on temperature sensor(s) 3. This step may include a time factor or temperature averaging as described above. If the temperature is determined to be critical in step 73, the process proceeds to step 75. In step 75 the system determines based on motion detector 5 whether a being is inside the vehicle. If both conditions exist in step 73 and 75, then the rescue sequence is initiated.

In a first step, the doors may be unlocked at step 77. Depending on the particular system one all or any number of doors may be unlocked depending on the system and/or user preference. Most automobiles today contain electric door locks 9, which are thus connected to the controller 1, and unlocked upon determination of injurious conditions as described above. The next step is that an alarm may also be sounded at step 79 with or without voice playback of a message 18, as is depicted in this particular embodiment. Step 79 may also include a sounding of a vehicle's horn or a siren.

In another step, a first phone call 81 may be placed to a certain number using the phone device 11. The first call 81 may be made to a local emergency number such as “911” at step 57. When the call is connected, a recorded voice message 13, global positioning data 17 and/or image data from camera 14 may be transmitted. For example, upon determination of a temperature outside a specific range coupled with motion detected within the vehicle, the closest police station may be automatically dialed on the phone device at direction of the controller 1. A message containing a generic description describing a person being trapped in the vehicle along with the address where the vehicle is located may be provided to an answering “911” dispatcher. Prompt notification of rescuers of the potential injurious situation along with the necessary location information to enable rescuers to provide a rescue, increases the likelihood of successful rescues. The automated call permits emergency rescue services to determine the extent of the emergency, who or what is involved, the location of the emergency, whether or not there is a false alarm, and/or specifics that may assist any rescue. Alternatively, the system may play voice message 13 and global positioning data 17, and query the emergency organization to determine whether it has image ready capabilities so as to see images.

The same described above with respect to a first call may be repeated in a second call at step 83 to a number designated by the user. For example, this call may be to a user's cell phone or PDA. Alternatively, an electronic message or page may be sent to a predetermined destination. The sequence and/or number of automated calls 57 may be varied as desired.

Additionally, the controller 1 also may cause the headlights 21 to flash at step 85 so as to bring more attention to the vehicle 100 which may be beneficial in identifying of a vehicle in a parking lot with a lot of other cars. Further, the controller 1 of the system in FIG. 3 may have determined that the temperature within the passenger compartment is above a predetermined value at step 87 (i.e. it is too hot) and may take further action. In such an event, the controller 1, attached to the power windows 23, may lower one or more windows 21 to allow the temperature within the vehicle to decrease as cooler outside air enters through the open window at step 89. The risk of injury related to exposure to high temperatures is thereby be reduced. Similarly, climate or temperature control systems such as air conditioning or heating systems 20 may be automatically activated to adjust the temperature within the vehicle if it is too hot or too cold. The steps 77, 79, 81, 83, 85, and 89 need not be performed in the order described above and may be performed simultaneously and/or in an alternative order. The system may remain in the rescue mode and continuously play alarm 79 and flash lights 85 until the system is determined to be reset at step 91.

While the embodiments of the system described in the figures are for exemplary and explanatory purposes, numerous arrangements of components, sensors, or detectors may be utilized consistent with the teaching of this invention. For example, the system may be initiated through depression of an on/off button or it may be automatically initiated according to the position of the ignition key as is well known in the art. Further, a reset button may also be utilized.

Generally the present invention will prevent injuries to human beings (especially children), animals, and other living creatures that may be confined within a vehicle at a time when the temperature within the vehicle may increase the risk of injury or death. Upon determination that these increased risk conditions exist, the system acts to alert the owner or operator of the vehicle, authorities, a government organization likely to assist, or fire/police rescue personnel of the danger.

The system may also facilitate bystander intervention by enabling would-be rescuers to more easily obtain access to the interior of the vehicle to assist any beings inside. The system may also draw attention to the vehicle thereby increasing the likelihood that the potentially perilous situation exists. Also, the system may provide the location of the vehicle, facts surrounding the circumstances of the vehicle and the being inside, relevant information pertaining to a possible rescuer and/or ownership information regarding the vehicle to facilitate rescuers in preventing injury through quick and appropriate responses.

Numerous combinations of bystander rescue facilitating measures in response to a determination that the temperature is too high or low and someone/something is moving within the vehicle may be used. These exemplary bystander rescue facilitating measures may include unlocking doors, sounding alarms, placing phone calls, lower windows, flashing headlights, and providing a location. However, any other commonly known bystander rescue facilitating measures may be utilized and have been contemplated.

While particular embodiments of the invention have been shown and described, it is recognized that various modifications thereof may be apparent to those skilled in the art without departing from its spirit. Therefore, the scope described invention shall be limited solely by the claims appended hereto.

1. A method of preventing injury or death to an occupant within a vehicle comprising the steps of:
determining if a temperature within a portion of the vehicle is critical;
detecting whether there is motion within a portion of the vehicle; and
if the temperature is determined to be critical and motion is detected within a portion of the vehicle, initiating a rescue sequence including the step of unlocking at least one door of the vehicle.

2. The method of claim 1 wherein the rescue sequence includes sounding a car horn.

3. The method of claim 1 wherein the rescue sequence includes the step of sounding an audible alarm.

4. The method of claim 3 wherein the step of sounding an audible alarm includes playing a recorded voice message.

5. The method of claim 4 wherein the rescue sequence further comprises the step of automatically calling a phone number and conveying global positioning data.

6. The method of claim 4 wherein the rescue sequence further comprises the step of automatically calling a user entered phone number.

7. The method of claim 2 wherein the rescue sequence further comprises the step of lowering a window.

8. The method of claim 1 wherein the rescue sequence further comprises the step of wirelessly transmitting an electronic image produced within the vehicle.

9. A method of preventing injury or death to an occupant within a vehicle comprising the steps of:
determining if a temperature within a portion of the vehicle is critical;
detecting whether there is motion within a portion of the vehicle; and
if a temperature is critical and motion is detected within the vehicle, initiating a rescue sequence, said rescue sequence including the step of placing an automated telephone call to a predetermined phone number.

10. The method of claim 9 wherein said automated telephone call is made to a user entered number.

11. The method of claim 9 wherein said automated telephone call is made to an emergency response number.

12. The method of claim 9 wherein the rescue sequence further includes placing successive automated telephone calls to different predesignated phone numbers.

13. The method of claim 12 wherein at least one of the successive telephone calls includes the step of conveying global positioning data.

14. The method of claim 9 wherein the rescue sequence further comprises the step of activating a climate control system within the vehicle.

15. The method of claim 9 wherein the rescue sequence further comprises the step of automatically sending electronic images captured from within the vehicle.

16. A method of preventing injury or death to an occupant within a vehicle comprising the steps of:
determining if a temperature within a portion of the vehicle is critical;
detecting whether there is motion within a portion of the vehicle; and
if the temperature is critical and motion is detected within a portion of the vehicle, initiating a rescue sequence including the step of unlocking a locked door of the vehicle and making a plurality of automated telephone calls.

17. The method of claim 16 wherein the rescue sequence further comprises the step of wirelessly transmitting images from within the vehicle.

18. The method of claim 17 wherein at least one of said calls is made to an emergency response number.

19. The method of claim 17 wherein the step of making at least one of said calls includes the step of transmitting global positioning data.

20. The method of claim 19 wherein the rescue sequence comprises the step of flashing the headlights on the vehicle.
